(19) United States
(12) Patent Application Publication
(10) Pub. No.: US 2019/0052379 A1
(43) Pub. Date: Feb. 14, 2019

(54) METHODS ON RADIO RESOURCE MANAGEMENT AND RADIO LINK MONITORING CONFIGURATIONS AND PROCEDURES

(71) Applicant: MediaTek Inc., Hsin-Chu (TW)

(72) Inventors: Hsuan-Li Lin, Hsin-Chu (TW); Tsang-Wei Yu, Hsin-Chu (TW)

(21) Appl. No.: 16/059,942

(22) Filed: Aug. 9, 2018

Related U.S. Application Data
(60) Provisional application No. 62/544,136, filed on Aug. 11, 2017.
(60) Provisional application No. 62/544,142, filed on Aug. 11, 2017.

(51) Int. Cl. H04B 17/318; H04W 24/10; H04W 56/00; H04W 72/04; H04L 1/00

(52) U.S. Cl. CPC H04B 17/318; H04W 24/10; H04L 5/0048; H04W 72/0446; H04L 1/0026; H04W 56/001

(57) ABSTRACT

Methods on radio resource management (RRM) configurations and procedures in wireless communication are described herein. In particular, methods are described for providing a reference signal strength indicator (RSSI) measurement timing configuration (RMTC). In some embodiments, a UE may perform a RSSI measurement based on the RMTC on at least on downlink (DL) symbol outside of a synchronization signal (SS) block. Also described herein are methods for inter-frequency SSB measurement, and methods for RLM configurations and procedures.

### CROSS-REFERENCE TO RELATED APPLICATIONS

This application claims the benefit under 35 U.S.C. § 119(e) of U.S. patent application Ser. No. 62/544,142, filed Aug. 11, 2017, entitled “Method on NR RRM configuration and measurement based on SS Blocks and CSI-RS,” and of U.S. patent application Ser. No. 62/544,136, filed Aug. 11, 2017, entitled “Method on RLM Configurations & Procedures,” both of which are hereby incorporated herein by reference in their entirety.

### BACKGROUND

The present application relates generally to methods and apparatus for mobile communication. In particular, it relates to configurations and procedures for radio resource management (RRM) and radio link monitoring (RLM).

In a wireless communication system, a user equipment (UE) such as a wireless device may communicate with one or more network elements to transmit and receive information representing data, voice and control signals. A wireless communication system may use RRM techniques to make measurements such as the signal strength of the serving cell and neighboring cell(s). RLM measurement may be used to evaluate the radio link failure by measuring the link quality from the serving cell. During operation, the network element periodically transmits reference signals that the UE can measure. When the receiver of the UE is tuned to a frequency of a first cell and a second cell broadcasting on a different frequency is available, the network element may schedule measurement gaps such that the UE can tune its receiver to the frequency of the second cell in order to perform inter-frequency measurements on the second cell. In LTE, cells are continuously transmitting cell-specific reference signals and broadcasting system information, regardless of the traffic activity in the cell. RRM can be based on discovery reference signal (DRS). In LTE, DRS consists of a combination of existing signals, such as synchronization signal (SS) to assist in obtaining the cell identity and coarse frequency and time synchronization; cell-specific reference signals (CRS) to assist in obtaining fine frequency and time synchronization; and channel state information (CSI) reference signals (CSI-RS) to determine the transmission point identity within the cell. The UE is may base cell identification and RRM measurements such as reference signal received power (RSRP) and reference signal received quality (RSRQ) on the DRS. To assist the UE in performing measurements, a timing configuration may be identified by the UE to provide information on when and what to measure for each physical-layer cell identity.

### SUMMARY

According to some embodiments, a method of wireless communication with a user equipment (UE) is provided. The method comprises identifying a reference signal strength indicator (RSSI) measurement timing configuration (RMTC); based on the RMTC, performing a RSSI measurement on at least one downlink (DL) symbol outside of a synchronization signal (SS) block received from a first cell.

According to some embodiments, a method of wireless communication with a user equipment (UE) for layer-3 mobility is provided. The method comprises identifying a timing configuration of channel state information reference signal (CSI-RS); based on the timing configuration, performing a radio resource management (RRM) measurement on CSI-RS, wherein the timing configuration comprises at least one of: a resource configuration indicating a position of a CSI-RS time or frequency resource within a slot, a subframe offset, and a slot offset relative to a beginning of transmission of a synchronization signal (SS) burst.

According to some embodiments, a method of wireless communication with a user equipment (UE) is provided. The method comprises identifying a radio link monitoring (RLM) configuration; based on the RLM configuration, performing a plurality of RLM measurements on a reference signal (RS). The RLM configuration comprises at least one of: a first parameter indicating an association between the RS and a control channel, and a second parameter indicating an association between the RS and an in-sync/out-of-synch (IS/OOS) indication.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic diagram of a mobile communication system 100 to which disclosures in the present application may be applied;

FIG. 2 is a schematic diagram illustrating a transmission 200 received at a UE, according to embodiments of the present application;

FIG. 3 is a flow chart of a method 300 of wireless communication with a UE, in accordance with some embodiments;

FIG. 4 is a schematic diagram illustrating a transmission 400a received from a serving cell, and a transmission 400b receiving from a neighboring cell, according to embodiments of the present application;

FIG. 5 is a flow chart of a method 500 of wireless communication with a UE for L3 mobility, in accordance with some embodiments; and

FIG. 6 is a flow chart of a method 600 of wireless communication with a UE, in accordance with some embodiments.

### DETAILED DESCRIPTION

The following is a list of abbreviations that may be found in the specification and/or the drawings.
5G-NB 5G Node B
CORESET Control channel resource set
CRS Cell-specific Reference Signals
CSI-RS Channel State Information Reference Signal
DL DownLink
DMRS DeModulation Reference Signal
gNB gNode B (5G base station)
HO HandOver
ID Identification
IS In-Synch
MG Measurement gap
NBR NeighBoRing
NR New Radio (5G)
NW NetWork
OFDM Orthogonal frequency-division multiplexing
OOS Out-Of-Synch
PBCH Physical Broadcast CHannel
QCL Quasi-CoLocated
RACH Random Access Channel
RF Radio frequency
RLF Radio Link Failure
RLM Radio Link Monitoring
RRM Radio Resource Management
RS Reference Signal
RSRP Reference Signal Received Power
RSRQ Reference Signal Received Quality
RSSI Received Signal Strength Indication
SINR Signal-and-Interference-to-Noise-Ratio
SS Synchronization Signal
SSB SS blocks
SSS Secondary Synchronization Signal
TDM Time Domain Multiplexing
UE User Equipment

Disclosed here are methods and a mobile communication device that provide configurations and procedures for RRM and RLM, and in particular, methods and a mobile communication device that provide RRM and RLM configurations and procedures when using 5G NR technology.

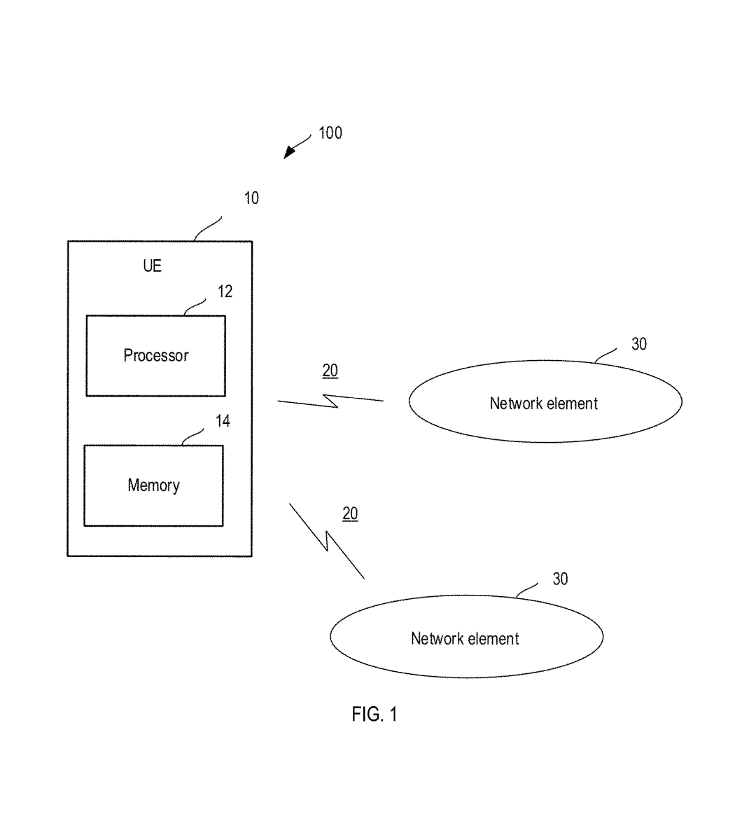

In a mobile communication system, a UE such as a mobile communication device may establish a link with a network element such as a cellular base station referred to as eNB for LTE, or gNB for 5G. The UE may communicate with the network element by transmitting or receiving voice, data and/or control signals. FIG. 1 is a schematic diagram of a mobile communication system 100 to which disclosures in the present application may be applied. Mobile communication system 100 includes UE 10 in connection 20 with network elements 30, in accordance with some embodiments. UE 10 may be fixed, or mobile, and may be referred to as a mobile communication device, a mobile device, a user terminal, a wireless device, a smartphone, or other terminologies. UE 10 has one or more processors 12 and one or more memories 14. The at least one memories 14 are configured to store executable instructions or codes that, when executed by the at least one processors 12, cause the UE 10 to perform one or more methods as described throughout the present application. The at least one memories 14 are also configured to store data to be transmitted to or received from the network element. The network element 30 is generally a fixed station and may be a gNB, or an eNB. Network element 30 may be referred to as a base station, a cellular base station, an access point, a cell, etc. Although two network elements 30 are shown connected with the UE 10, it should be appreciated that aspects of the present application are not limited to the scenarios illustrated in FIG. 1.

During operation of a mobile communication system, synchronization signals may be transmitted within a structure referred to as an “SS block.” An SS block may be composed of one or more SSs in various arrangements and, in some cases, other signals such as data symbols may be multiplexed within an SS block. In some cases, a “burst” of one or multiple SS block may be sent, sometimes referred to as an SS burst. An SS burst may be of various durations and SS blocks may or may not be consecutive within a burst and may or may not be the same. The inventors have recognized and appreciated that an SS block based RRM measurement timing configuration (hereinafter referred to as SMTC) may be identified by the UE to configure measurement window periodicity/duration/offset information for RRM measurement based on SS block. In some embodiments, for intra-frequency CONNECTED mode measurement, up to two measurement window periodicities can be configured. While in some embodiments, for IDLE mode and inter-frequency CONNECTED mode measurements, only one SMTC is configured per frequency band.

The inventors have recognized and appreciated that when RSSI measurement is made during an SS block, the measurement may not properly reflect the cell loading and interference level of data transmission. For example, in a beamforming scenario, interference level measured from SSB-RSRQ/SINR would differ from data transmission, and the cell loading could not be well reflected by SSB-RSRQ/SINR when measured during an SS block. According to an aspect of the present application, to solve such problems, RSSI may be measured from symbols outside of RS symbols, or outside of SS blocks. In some embodiments, a reference signal strength indicator (RSSI) measurement timing configuration (RMTC) may be provided. The UE performs RSSI measurements on DL symbol outside of an SS block received from a cell, based on the RMTC. The inventors have recognized and appreciated that measurements based on symbols outside of SS blocks may accurately reflect data interference level, and accurately reflect cell loading. Furthermore, measuring on DL symbols outside of SS blocks may allow UE to measure RSSI without requiring a wide bandwidth.

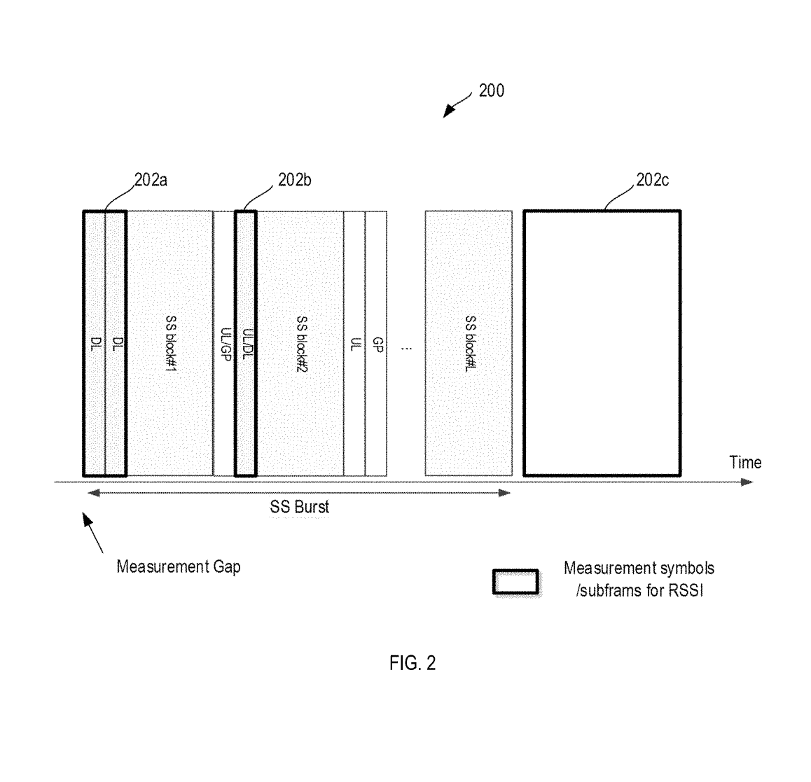

FIG. 2 is a schematic diagram illustrating a transmission 200 received at a UE, according to embodiments of the present application. According to an aspect of the present application, a RMTC may configure a RSSI measurements on DL symbol 202c outside of the SS burst, or DL symbols 202a, 202b inside the SS burst, but still outside of SS blocks.

The RMTC may be provided by a broadcasting cell, and may be signaled by higher layers in the UE for identification by the UE. In some embodiments, the UE may measure RSSI by averaging RSSI measurement over the DL symbol specified in the RMTC. In dynamic beamforming scenarios on the control and data channels, UE may derive a cell-level RSSI by averaging received power over DL symbols of measurement subframes. The UE may also derive beam-level RSSI associated with a beam of a plurality of beams by averaging received power over one or more QCLed OFDM symbols that are QCLed to the beam of the plurality of beams.

According to an aspect of the present application, the time location (subframes or slots) of a beginning of a RSSI measurement can be either selected by UE or indicated by higher layers through the RMTC. In some embodiments, the RMTC could be configured together with SSB Measurement Timing Configuration (SMTC). In some embodiments, the RMTC may include at least all or part of the following: the periodicity of RSSI measurement; the timing offset of RSSI symbols, which can be configured in the unit of symbols, slots, or subframes; the duration of RSSI measurement, which can be configured in the unit of symbols of the SSB in the measured frequency range, considering the subcarriers spacing could be different in different frequency range. The RMTC may also include, for one RSSI measurement, multiple timing offset and duration of one RSSI measurement.

In some embodiments, when the measurement gap is configured, UE will not perform inter-frequency measurement on the symbols configured by RSSI outside the measurement gap.

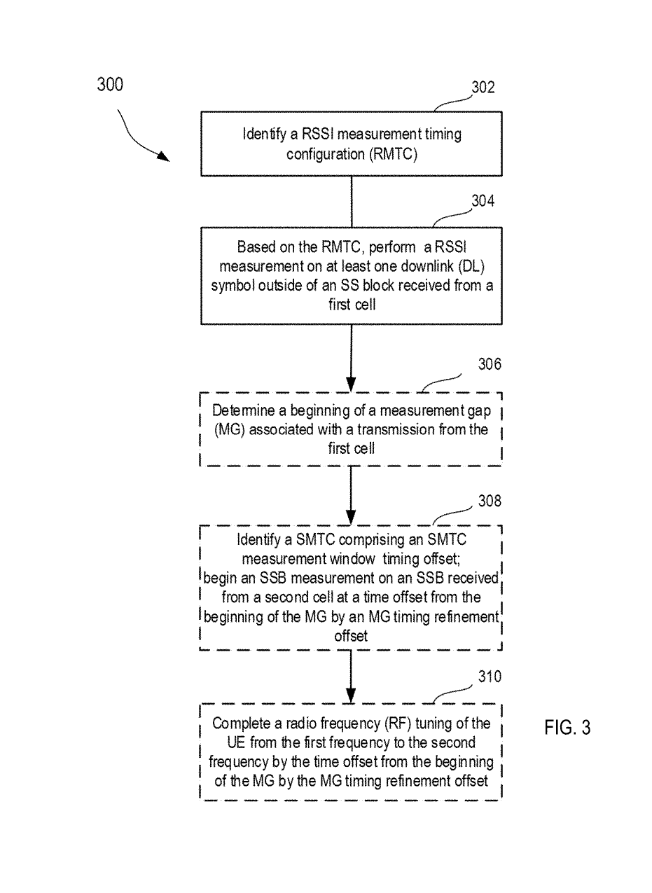

FIG. 3 is a flow chart of a method 300 of wireless communication with a UE, in accordance with some embodiments. As shown in FIG. 3, at act 302, method 300 comprises identifying a reference signal strength indicator (RSSI) measurement timing configuration (RMTC). At act 304, method 300 comprises based on the RMTC, performing a RSSI measurement on at least one downlink (DL) symbol outside of a synchronization signal (SS) block received from a first cell. Optionally and in inter-frequency measurements, at act 306, method 300 comprises determining a beginning of a measurement gap (MG) associated with a transmission from the first cell. At act 308, method 300 may optionally comprise identifying a synchronization signal block (SSB) measurement timing configuration (SMTC) comprising an SMTC measurement window timing offset; and beginning an SSB measurement on an SSB received from a second cell at a time offset from the beginning of the MG by an MG timing refinement offset. At act 310, method 300 may optionally comprise completing a radio frequency (RF) tuning of the UE from the first frequency to the second frequency by the time offset from the beginning of the MG by the MG timing refinement offset.

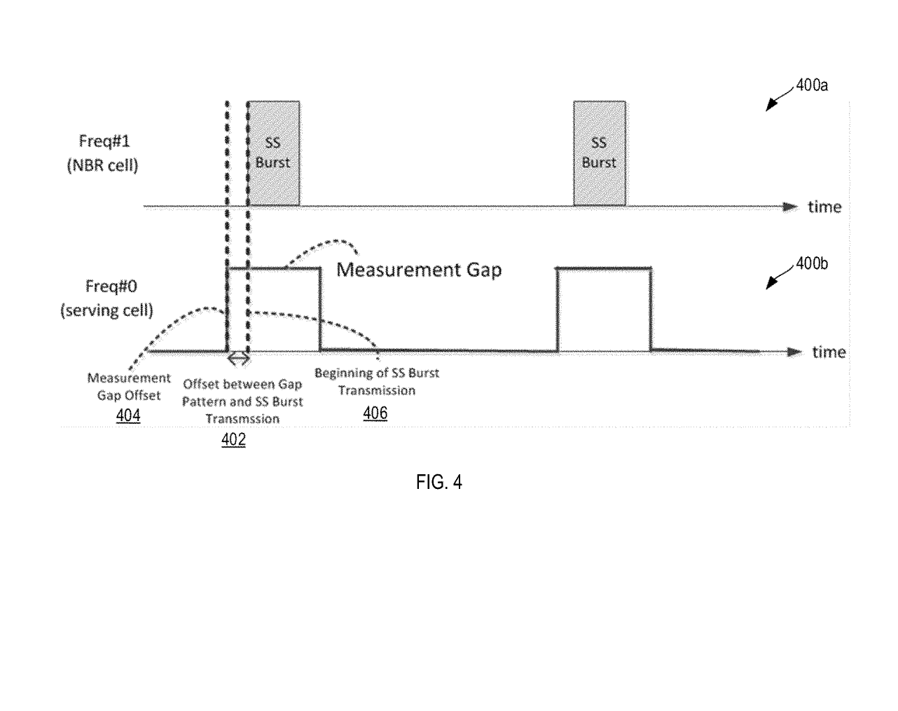

Aspects of the present application are related to a method for inter-frequency SSB measurement. FIG. 4 is a schematic diagram illustrating a transmission 400a received from a serving cell, and a transmission 400b receiving from a neighboring cell, according to embodiments of the present application. In FIG. 3, the serving cell has a frequency that is different from a frequency of the neighboring cell (NBR cell). The inventors have recognized and appreciated that for inter-frequency measurement, UE need a time gap for RF tuning. For example as shown in FIG. 3, if the beginning of measurement gap 404 in the serving cell and the beginning of SS burst 406 in a neighboring cell are aligned on the time axis, UE will miss some SS blocks due to the time needed to perform RF tuning. According to an aspect of the present application, an indication for a MG timing refinement offset, such as offset 402 as illustrated in FIG. 1, may be provided in a timing configuration to introduce a short offset between the beginning of the measurement gap pattern in the serving cell and the SS burst transmission in the NBR cell, to allow UE to perform RF tuning. In some embodiments, the MG timing refinement offset may be configured in the unit of a scheduling unit. In one non-limiting example, the MG timing refinement offset may be configured in the unit of a slot, a unit of half of a slot, or a unit of multiple symbols. In some embodiments, the MG timing refinement offset may have a time value of less than 1 ms, less than 0.5 ms, between 0 and 1 ms, between 0 and 0.5 ms, or between 0.25 and 0.75 ms. For example, a 0.25 ms, 0.5 ms, or 0.75 ms MG timing refinement offset may be provided.

In some embodiments, a scheduling unit such as a slot is divided into two parts. The forepart of a slot may be configured for a gNB to schedule data transmission. The behind part of a slot may be configured for a gNB to transmit SS blocks. A MG timing refinement offset indication may be configured in SMTC to indicate the timing of one or both parts of the slot.

In some embodiments, UE is configured to perform inter-frequency measuring on SS blocks with regarding to the SMTC and the configured indication of MG timing offset. Specifically, the UE is configured to tune RF of one or more of its receivers into the frequency after the configured MG timing refinement offset, and to complete RF tuning before the particular time that is offset from the beginning of the MG by the MG timing refinement offset.

Aspects of the present application are related to a method to provide timing configuration of CSI-RS for layer-3 (L3) mobility. The inventors have recognized and appreciated that in CSI-RS for L3 mobility, the UE may need SS block to provide cell detection and course synchronization of the timing and frequency in order to measure CSI-RS. The UE may also need SS block to provide TTI reference in order to measure CSI-RS. Furthermore, for an inter-frequency measurement, UE may need a time index to know the timing of CSI-RS. It may also need frame timing. According to an aspect of the present application, to solve these needs, a timing configuration of CSI-RS for L3 mobility may help perform CSI-RS measurement without knowing the frame timing of other frequency band.

In one embodiment, a timing offset of CSI-RS may be configured as subframe and slot offset. The CSI-RS time/frequency resource within a slot can be further configured by resource configuration. In such an embodiment, UE may need to know the frame timing to perform CSI-RS measurement. However, in an inter-frequency measurement, UE may not know the frame timing of the cells at other frequency range.

In another embodiment, a timing offset of CSI-RS may be configured as the slot offset to the associated SS block. The CSI-RS time/frequency resource within a slot can be further configured by resource configuration. In this embodiment, it should be appreciated that the frame timing may not be necessary to be known by UE, while UE may need to know the time index of SS block to perform CSI-RS measurement based on the associated SS block. However, for some deployments, e.g. multi-TRP cell, the CSI-RS may not be associated to certain SS block.

In yet another embodiment, a timing offset of CSI-RS may be configured as the slot offset to the beginning of SS burst transmission. The CSI-RS time/frequency resource within a slot can be further configured by resource configuration. In this embodiment, UE may need to know the time index of SS block to derive the beginning of SS burst transmission, and UE is able to perform measurement on CSI-RS based on the configured offset.

According to an aspect of the present application, a timing configuration of CSI-RS for L3 mobility may be provided. The timing configuration may include at least all or part of the following:
resource configuration, which configures the CSI-RS time/frequency resource within a slot, and
configurable subframe offset and slot offset, or
configurable slot offset to the associated SS block, or
configurable slot offset to the beginning of SS burst transmission

Further according to the aspect of the present application, UE may perform RRM measurement on CSI-RS with the following procedure:
Step 1. UE performs cell detection and course synchronization of the timing and frequency on SS blocks. UE obtains the cell ID after this step;
Step 2. UE derived the time index of the detected SS blocks. If the association between CSI-RS and SS block is configured, the UE derives the time index of detected SS blocks, which is associated to the configured CSI-RS;
Step 3. UE derived the timing reference based one the time index. The timing reference can be frame or slot timing derived by time index of detected SS block;
Step 4. UE perform the RRM measurement regarding the timing reference and the timing configuration.

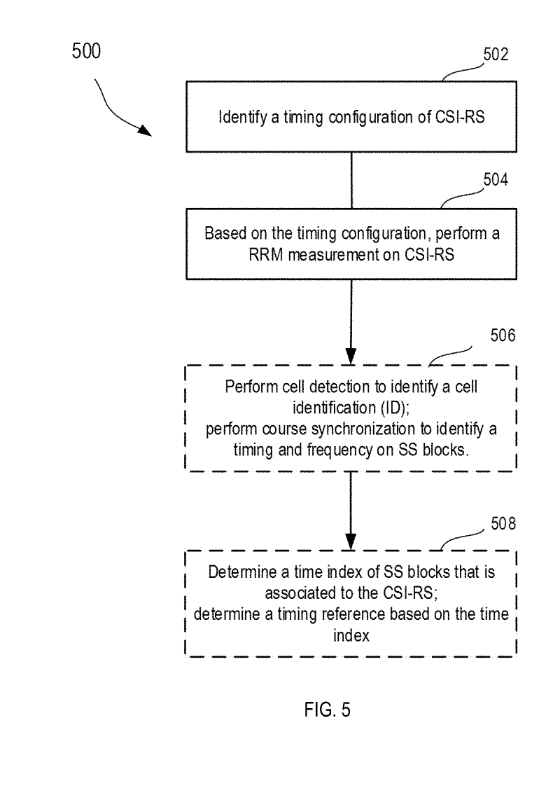

FIG. 5 is a flow chart of a method 500 of wireless communication with a UE for L3 mobility, in accordance with some embodiments. As shown in FIG. 5, at act 502, method 500 comprises identifying a timing configuration of channel state information reference signal (CSI-RS). At act 504, method 500 comprises based on the timing configuration, performing a radio resource management (RRM) measurement on CSI-RS. Optionally at act 506, method 500 further comprises performing cell detection to identify a cell identification (ID); performing course synchronization to identify a timing and frequency on SS blocks. At act 508, method 500 may optionally comprise determining a time index of SS blocks that is associated to the CSI-RS; and determining a timing reference based on the time index.

Aspects of the present application are related to a method on RLM configurations and procedures. The inventors have recognized and appreciated that a RLM configuration may be provided that includes at least all or part of the following:
a configurable power/energy/beamforming/precoding gain offset. The offset may capture the precoding mismatch between control channel and RLM RS. The offset may also capture the beamforming mismatch between different type of RLM RS (e.g. SS block (Common Control) and CSI-RS (Dedicated Control)).
a configurable RS type, e.g. SS block or CSI-RS
a configurable association between configured RS and control channel, including at least all or part of: spatial QCL or QCL assumption, CONRESET identification
a configurable association between configured RS and IS/OOS indication. In some embodiments, two sets of RSs may be used for IS and OOS indication derivation, respectively.

In some embodiments, the control channel can be a dedicated control channel, common control channel, group common control channel.

In some embodiments, two CSI-RS for RLM may be configured for UE. One (CSI-RS#1) for IS, the other (CSI-RS#2) for OSS. In such embodiments, a configurable power/energy/beamforming/precoding gain offset may be configured in RLM configuration. In one non-limiting example, for CSI-RS#1, an offset of 3 dB is provided for IS indication, an offset of 2 dB is provided for OSS indication, while for CSI-RS#2, an offset of −2 dB is provided for IS indication, an offset of −3 dB is provided for OSS indication. It should be appreciated that the above offset values are provided for illustration purpose only and aspects of the present application are not limited to such values.

In some embodiments, UE may derive the radio quality of CSI-RS#1 and CSI-RS#2 based on the measured SINR and offset for IS/OOS respectively. In one non-limiting example, for CSI-RS#1: measured SINR=10 dB, derived radio quality for IS=10 dB+3 dB=13 dB, derived radio quality for OOS=10 dB+2 dB=12 dB. For CSI-RS#2: measured SINR=6 dB , derived radio quality for IS=6 dB+−3 dB=4 dB, derived radio quality for OOS=6 dB−3 dB=3 dB. It should be appreciated that the above values are provided for illustration purpose only and aspects of the present application are not limited to such values.

In some embodiments, if all the derived radio quality on the CSI-RS are worse than the predefined threshold (Q_{OUT}), an OOS indication is sent. In one non-limiting example, if Qout=12.5 dB, the OOS is sent by UE since derived radio quality of all CSI-RSs for OOS are (12 dB, 3 dB) M 12.5 dB. If one of the derived radio quality on the CSI-RS is better than the predefined threshold (Qᵢₙ), an IN indication is sent. In one non-limiting example, if Qin=12.5 dB, the IS is sent by UE since derived radio quality of CSI-RS#1 for IS is 13 dB>12.5 dB.

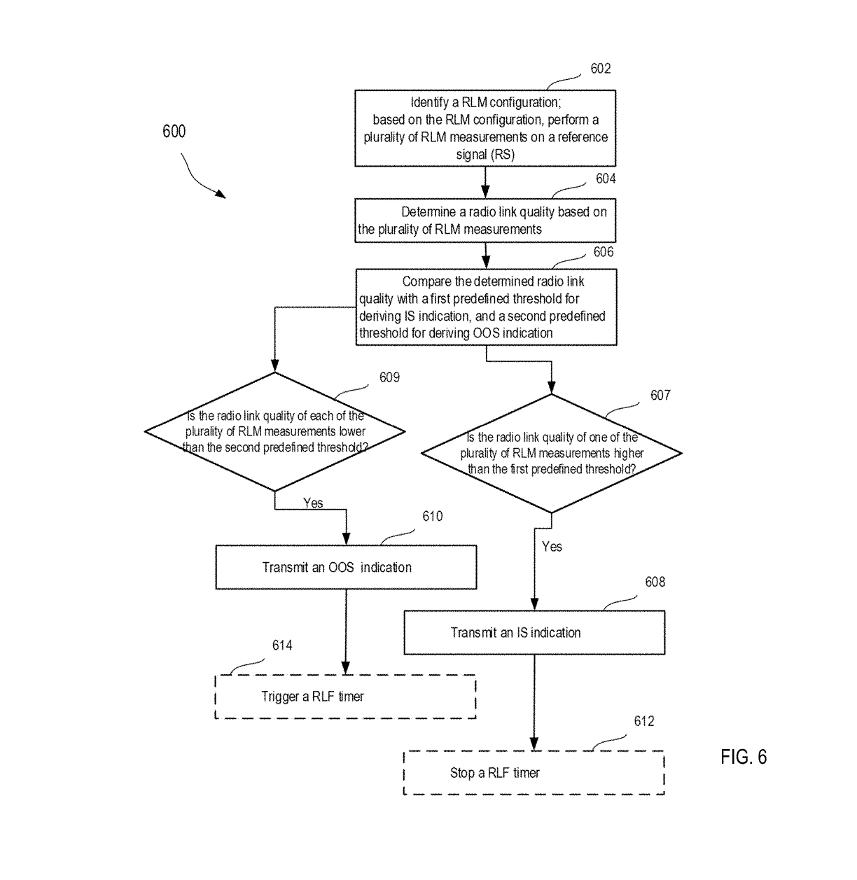

FIG. 6 is a flow chart of a method 600 of wireless communication with a UE, in accordance with some embodiments. As shown in FIG. 6, at act 602, method 600 comprises identifying a radio link monitoring (RLM) configuration; and based on the RLM configuration, performing a plurality of RLM measurements on a reference signal (RS). At act 604, method 600 comprises determining a radio link quality based on the plurality of RLM measurements. At act 606, method 600 comprises comparing the determined radio link quality with a first predefined threshold for deriving IS indication, and comparing the determined radio link quality with a second predefined threshold for deriving OOS indication. At act 607, if the determined radio link quality of one of the plurality of RLM measurements is higher than the first predefined threshold, the method at act 608 transmits an IS indication. At act 609, if the determined radio link quality of each of the plurality of RLM measurements is lower than the predefined threshold, the method at act 610 transmits an OOS indication. At act 612, method 600 may optionally comprise stopping a radio link failure (RLF) timer. At act 614, method 600 may optionally comprise triggering a radio link failure (RLF) timer.

Having thus described several aspects of at least one embodiment of this invention, it is to be appreciated that various alterations, modifications, and improvements will readily occur to those skilled in the art.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of wireless communication with a user equipment (UE), the method comprising:
identifying a reference signal strength indicator (RSSI) measurement timing configuration (RMTC);
based on the RMTC, performing a RSSI measurement on at least one downlink (DL) symbol outside of a synchronization signal (SS) block received from a first cell.

2. The method of claim 1, wherein the at least one DL symbol is within an SS burst.

3. The method of claim 1, wherein the at least one DL symbol is outside of an SS burst.

4. The method of claim 1, wherein the RMTC is received from the first cell.

5. The method of claim 1, wherein the RSSI measurement is an average RSSI measurement over the at least one DL symbol.

6. The method of claim 5, further comprising receiving a plurality of beams from the first cell, wherein the at least one DL symbol comprises a symbol quasi-colocated (QCLed) to a beam of the plurality of beams, and the average RSSI measurement is a beam-level RSSI associated with the beam of the plurality of beams.

7. The method of claim 1, wherein the RMTC comprises at least one of:
a time location of a beginning of the RSSI measurement,
a measurement duration of the RSSI measurement, and
a periodicity of two or more RSSI measurements.

8. The method of claim 1, further comprising:
determining a beginning of a measurement gap (MG) associated with a transmission from the first cell;
identifying a synchronization signal block (SSB) measurement timing configuration (SMTC) comprising an SMTC measurement window timing offset;
beginning an SSB measurement on an SSB received from a second cell at a time offset from the beginning of the MG by an MG timing refinement offset, wherein
the MG timing refinement offset is less than 1 ms.

9. The method of claim 8, wherein the SSB measurement is not performed during the MG timing refinement offset after the beginning of the MG.

10. The method of claim 8, wherein the MG timing refinement offset is 0.5 ms or less.

11. The method of claim 8, wherein the MG timing refinement offset is half a slot or multiple symbols.

12. The method of claim 8, wherein the first cell has a first frequency and the second cell has a second frequency different from the first frequency, the method further comprising:
completing a radio frequency (RF) tuning of the UE from the first frequency to the second frequency by the time offset from the beginning of the MG by the MG timing refinement offset.

13. A method of wireless communication with a user equipment (UE) for layer-3 mobility, the method comprising:
identifying a timing configuration of channel state information reference signal (CSI-RS);
based on the timing configuration, performing a radio resource management (RRM) measurement on CSI-RS, wherein the timing configuration comprises at least one of:
a resource configuration indicating a position of a CSI-RS time or frequency resource within a slot,
a subframe offset, and
a slot offset relative to a beginning of transmission of a synchronization signal (SS) burst.

14. The method of claim 13, further comprising:
performing cell detection to identify a cell identification (ID);
performing course synchronization to identify a timing and frequency on SS blocks.

15. The method of claim 14, further comprising:
determining a time index of SS blocks that is associated to the CSI-RS;
determining a timing reference based on the time index, wherein the timing reference is a frame or slot timing determined based on the time index of SS blocks, wherein
performing the RRM measurement further comprises performing the RRM measurement based on the timing reference.

16. A method of wireless communication with a user equipment (UE), the method comprising:
identifying a radio link monitoring (RLM) configuration;
based on the RLM configuration, performing a plurality of RLM measurements on a reference signal (RS), wherein the RLM configuration comprises at least one of:
a first parameter indicating an association between the RS and a control channel,
a second parameter indicating an association between the RS and an in-sync/out-of-synch (IS/OOS) indication.

17. The method of claim 16, wherein the first parameter comprises at least one of:
a spatial quasi-colocation (QCL), a QCL assumption, and a control channel resource set (CONRESET) identification.

18. The method of claim 16, wherein the control channel is a dedicated control channel, a common control channel, or a group common control channel.

19. The method of claim 16, further comprising:
determining a radio link quality based on the plurality of RLM measurements;
comparing the determined radio link quality with a first predefined threshold for deriving IS indication and a second predefined threshold for deriving OOS indication;
in response to an indication that the determined radio link quality of one of the plurality of RLM measurements is higher than the first predefined threshold, transmitting an IS indication;
in response to an indication that the determined radio link quality of each of the plurality of RLM measurements is lower than the second predefined threshold, transmitting an OOS indication.

20. The method of claim 19, further comprising at least one of:
upon transmitting consecutive OOS indications, triggering a radio link failure (RLF) timer, and
upon transmitting consecutive IS indications, stopping a radio link failure (RLF) timer.
